(19) United States
(12) Patent Application Publication
(10) Pub. No.: US 2026/0183755 A1
(43) Pub. Date: Jul. 2, 2026

(54) HYDROPROCESSING CATALYST

(71) Applicant: UOP LLC, Rosemont, IL (US)

(72) Inventors: Phuong T. M. Do, Mt. Prospect, IL (US); Steven Francis Zink, Batavia, IL (US)

(21) Appl. No.: 19/379,515

(22) Filed: Nov. 4, 2025

Related U.S. Application Data
(60) Provisional application No. 63/739,994, filed on Dec. 30, 2024.

(51) Int. Cl. B01J 23/882; B01J 21/04; B01J 23/883; B01J 35/61; B01J 35/63; B01J 35/64; B01J 37/02; B01J 37/12; B01J 37/20

(52) U.S. Cl. CPC B01J 23/882; B01J 21/04; B01J 23/883; B01J 35/615; B01J 35/638; B01J 35/647; B01J 37/0201; B01J 37/12; B01J 37/20

(57) ABSTRACT

A hydroprocessing catalyst is provided that is supported hydrotreating catalyst, where the shaped support of 0.36-0.46 void fraction is comprised of a single source of gamma alumina with a medium pore diameter of 10 nm and at least 0.95 cc/g pore volume but not more than 1.10 cc/g, and includes a single, Group IIIb metal dispersed by mulling or mixing in a forming step, and a surface area by nitrogen BET between about 230 m²/g and 260 m²/g, and where the finished catalyst can be described in terms of molar ratios relative to aluminum, where the aluminum concentration may vary from 26 to 30 wt %, Al: Group VIb 4.8-5.6, Al: Group VIII 14.9-19.0, Al: Group Va 9.6-12.7, and Al: Group IIIb 112.5-228.2.

### FIELD

This disclosure relates to a catalyst for use in hydroprocessing. The hydroprocessing may include hydrodenitrogenation, hydrodesulfurization, hydrodemetallation, hydrodesilication, hydrodearomatization, hydroisomerization, hydrotreating, hydrofining, and hydrocracking.

### BACKGROUND

In the catalytic hydroprocessing of hydrocarbon feedstocks particulate catalysts are used to promote such reactions as desulfurization, denitrogenation, demetallization, and cracking. This is done by contacting the particulate catalyst with hydrocarbon feedstocks such as gas oils, distillates (e.g., diesel and kerosene), naphthas and gasolines under conditions of elevated temperature and pressure and in the presence of hydrogen. With hydrodesulfurization, the organic sulfur components of the hydrocarbon feedstock are converted to hydrogen sulfide, and, with hydrodenitrogenation, the organic nitrogen components of the hydrocarbon feedstock are converted to ammonia. Currently there are two main drivers for refiners to invest in hydroprocessing technology. The first being environmental regulations imposing more stringent specifications on fuels including gasoline, diesel, and even fuel oils. For example, permitted sulfur and nitrogen levels in fuels are significantly lower than one decade ago. A second driving force is the quality of crude oils. More refineries are facing crude oils containing higher concentrations of sulfur and nitrogen compounds which are difficult to process or remove by conventional processes. Without new technology, refiners resort to increasing the severity of hydrotreating processes either by increasing the reactor temperatures or decreasing space velocity through the reactor. Increasing reactor temperature has the drawback of shortening catalyst lifetime. Decreasing space velocity, through increasing reactor size or decreasing feed flow rates, has the drawback of overhauling the reactors or significantly reducing production rates. Therefore, a highly active hydroprocessing catalyst is needed. A highly active hydroprocessing catalyst helps the refiners meet the stringent fuel sulfur and nitrogen limitations without significant investment in reactors and equipment and while maintaining production rates. In addition, there is an increasing need to process renewable oils for fuel and petrochemical applications.

A typical hydroprocessing catalyst contains one or more hydrogenation metal and, optionally, one or more promoter, that are supported on a porous refractory oxide support. The hydrogenation metal is typically a Group VIb metal or a Group VIII metal, or a combination of both such metals, that is used as an active component supported on a porous refractory oxide, such as alumina. A promoter, such as phosphorous, may also be incorporated into the porous refractory oxide. These hydroprocessing catalysts are typically prepared by impregnation of the active components into the support by contacting it with an aqueous solution containing the active components in dissolved form. The impregnated support is then usually dried and calcined to convert the active metals and promoters to the oxide form. The catalyst is then activated, usually by sulfiding, to prepare it for use.

There is a need for new materials to meet increasing demands of conversion processes including the need for catalysts with higher intrinsic activity per mass. Further, there is a need to synthesize these catalysts in a manufacturing-friendly way. There is a need to produce the catalysts and catalyst precursors that have high activity, that is catalysts that maintain the same performance but at lower temperatures than the next best alternative catalysts.

### SUMMARY

A supported hydrotreating catalyst is provided that has Group VIb, Group VIII, and Group Va elements that are all added to the support in a single step, in the form of a single impregnating solution, which also includes at least one tridentate carboxylic acid and at least one tetradentate aminocarboxylic acid, where the molar ratio of the tridentate carboxylic acid: Group VIII metal is at least 1.55:1 and the molar ratio of the tetradentate aminocarboxylic acid: Group VIII metal is at least 0.15:1. The supported hydrotreating catalyst, where the shaped support of 0.36-0.46 void fraction is comprised of a single source of gamma alumina with a medium pore diameter of 10 nm and at least 0.95 cc/g pore volume but not more than 1.10 cc/g (by ASTM D8413 method), and includes a single, Group IIIb metal dispersed by mulling or mixing in a forming step, and a surface area by nitrogen BET of at least 190 m²/g, and where the finished catalyst can be described in terms of molar ratios relative to aluminum, where the aluminum concentration may vary from 26 to 30 wt %, and the molar ratio of aluminum to the indicated elements as Al: Group VIb 4.8-5.6, Al: Group VIII 14.9-19.0, Al: Group Va 9.6-12.7, and Al: Group IIIb 112.5-228.2.

The conversion process may be a hydrocarbon conversion process. The conversion process may be hydroprocessing. The conversion process may be hydrodenitrogenation, hydrodesulfurization, hydrodemetallation, hydrodesilication, hydrodearomatization, hydroisomerization, hydrotreating, hydrofining, or hydrocracking.

Additional features and advantages of the invention will be apparent from the description of the invention and claims provided herein.

### DETAILED DESCRIPTION

The present disclosure relates to a method of making supported hydroprocessing catalysts which include metals from Group VIb, Group VIII and Group IIIb metals. The metals may include Mo, Ni, and a rare earth element, for example.

The catalyst will have a gamma alumina support. A method of manufacturing this catalyst will involve using a multilobe, gamma-alumina support extruded with 0.5-2.0 wt % rare earth element (volatile-free basis) with 90-200 Angstroms median pore diameter, and at least 0.95 cc/g pore volume (e.g. by ASTM D8413 method) but not more than 1.10 cc/g pore volume and an impregnation solution to fill the support's volume with up to 20% excess solution (incipient wetness/pore-filling). Preparing the solution in a single vessel, by following a sequence of activities, is preferred vs. preparing portions of the impregnating solution in multiple vessels and then combining these. Full penetration of the gamma alumina support with solution may require up to 2 hours. The composition of the finished catalyst has the following specifications: group VIb (volatile-free basis) of 19.5-21%, and the remaining portion of the finished catalyst can be described in terms of molar ratios relative to aluminum, where the aluminum concentration may vary from 26 to 30 wt %, and the molar ratio of aluminum to the indicated elements as Al: Group VIb 4.8-5.6, Al: Group VIII 14.9-19.0, Al: Group Va 9.6-12.7, and Al: Group IIIb 112.5-228.2, tridentate carboxylic acid: group VIII molar ratio 1.5-2.0:1, and tetradentate aminocarboxylic acid: group VIII molar ratio 0.15-0.20:1, where the weight percent of volatiles as measured at 500 C shall be 18-22 wt %.

The catalyst may be loaded by sock loading or dense loading in supported transition metal oxide form or in supported transition metal sulfide form. From supported transition metal oxide form, the catalyst is ordinarily sulfided after loading, in situ with a sulfur dopant such DMDS dispersed in a diesel medium, or sulfided ex situ prior to loading. To enable the highest activity for hydrotreatment of fossil-derived naphtha, diesel, and vacuum gasoil, and/or to enable the highest activity for hydrotreatment of bio-derived oils, the catalyst is ordinarily sulfided. The operating conditions needed to conduct sufficient hydrotreating are 0.1-15 liquid hourly space velocity, 100-15000 standard cubic feet molecular hydrogen/barrel feed, 200-2500 psig, and 350-800 deg F.

The reaction time may range from about 0.5 to about 200 h, or 0.5 h to about 100 h, or from about 1 h to about 50 h, or from about 2 h to about 24 h.

A supported hydrotreating catalyst, where the shaped support of 0.36-0.46 void fraction is comprised of a single source of gamma alumina with a medium pore diameter of at least 100 Angstroms but not more than 130 Angstroms and at least 0.95 cc/g pore volume but not more than 1.10 cc/g, and includes a single, Group 3 metal dispersed by mulling or mixing in a forming step, and a surface area by nitrogen BET a between about 230 m²/g and 260 m²/g, and where the finished catalyst can be described in terms of molar ratios relative to aluminum, where the aluminum concentration may vary from 26 to 30 wt %. The molar ratio of aluminum to Group VIb, Group VIII, Group Va and Group IIIb elements may range from Al: Group VIb 4.8-5.6, Al: Group VIII 14.9-19.0, Al: Group Va 9.6-12.7, and Al: Group IIIb 112.5-228.2.

The Group VIb, Group VIII, and Group Va elements are all added to the support in a single step, in the form of a single impregnating solution, which also includes at least one tridentate carboxylic acid and at least one tetradentate aminocarboxylic acid, where the molar ratio of the tridentate carboxylic acid: Group VIII metal is at least 1.55:1 and the molar ratio of the tetradentate aminocarboxylic acid: Group VIII metal is at least 0.15:1.

The resulting impregnated catalyst is subjected to an oxidizing atmosphere so that the resulting catalyst shall have a volatiles content (500° C.) of at least 18% but not more than 22 wt %, resulting in a N₂ BET surface area that is at least 230 m²/g but not more than 260 m²/g.

The method provides for the preparation of a hydroprocessing catalyst that has a high metals loading and a particularly high activity for hydrodenitrogenation. It is believed that the inventive catalyst composition prepared by this novel method, with high activity due to the high loading of metals and other additives, is enabled by the high pore volume and high surface area of the catalyst support. The high pore volume of the catalyst support also enables the impregnation to be conducted with an impregnating solution that is prepared entirely in only one vessel.

The catalyst composition of the invention comprises a high loading level of one or more active metals or active metal precursors that are incorporated onto a support material. The active metal or metals are, in general, incorporated into the support material by any standard solution impregnation method known to those skilled in the art for incorporating active metal or metals into or onto a support material.

At least a portion of the catalyst material, with or without a binder, or before or after inclusion of a binder, can be sulfided in situ in an application or pre-sulfided to form metal sulfides which in turn are used as catalysts in an application. The sulfidation may be conducted under a variety of sulfidation conditions such as through contact of the catalyst with a sulfur containing stream or feedstream as well as the use of a gaseous mixture of H₂S/H₂. The sulfidation of the catalyst material is performed at elevated temperatures, typically ranging from 50 to 600° C., or from 150 to 500° C., or from 250 to 450° C. The materials resulting from the sulfiding step are referred to as metal sulfides which can be used as catalysts in conversion processes.

As discussed, at least a portion of the catalyst material of this invention can be sulfided and the resulting metal sulfides used as catalysts in conversion processes such as hydrocarbon conversion processes. Hydroprocessing is one class of hydrocarbon conversion processes in which the mixed transition metal oxide material is useful as a catalyst. Examples of specific hydroprocessing processes are well known in the art and include hydrodenitrogenation, hydrodesulfurization, hydrodemetallation, hydrodesilication, hydrodearomatization, hydroisomerization, hydrotreating, hydrofining, and hydrocracking. In one embodiment a conversion process comprises contacting the supported transition metal oxide material with a sulfiding agent to generate metal sulfides which are contacted with a feed stream at conversion conditions to generate at least one product.

The operating conditions of the hydroprocessing processes listed above typically include reaction temperatures in the range of about 175° C. to about 440° C. Contact time for the feed and the active catalyst, referred to as liquid hourly space velocities (LHSV), should be in the range of about 0.1 h-1 to about 15 h-1. Feed may be in the range from 100-15000 standard cubic feet molecular hydrogen/barrel feed, and pressures of about 200-2500 psig, Specific subsets of these ranges may be employed depending upon the feedstock being used. For example, when hydrotreating a typical diesel feedstock, operating conditions may include from about 3.5 MPa to about 8.6 MPa, from about 315° C. to about 800° C., from about 0.25 h⁻¹ to about 5 h⁻¹, and from about 84 Nm³ H₂/m³ to about 850 Nm³ H₂/m³ feed. Other feedstocks may include gasoline, naphtha, kerosene, gas oils, distillates, and reformate.

### EXAMPLES

### Example 1

In Table 1 in Example 1 is shown the properties of the vacuum gas oil feed 1.

TABLE 1

| Property | Unit | Feed 1 |
|---|---|---|
| Bromine | gBr/100 g | 15 |
| Number | | |
| Density at 60° F. | API | 20.94 |
| H Content by | Wt % | 12.13 |
| NMR | | |
| Heptane | Wt % | 0.024 |
| Insolubles | | |
| Nitrogen | WT PPM | 1103 |
| SULFUR | Wt % | 1.8 |
| GC Simdist | | |
| Initial boiling | F | 577 |
| point | | |
| Sim Dist 5 | F | 666 |
| Sim Dist 10 | F | 699 |
| Sim Dist 30 | F | 779 |
| Sim Dist 50 | F | 840 |
| Sim Dist 70 | F | 906 |
| Sim Dist 90 | F | 998 |
| Sim Dist 95 | F | 1038 |
| Final boiling | F | 1109 |
| point | | |

### Example 2

This example provides the process steps for the preparation of Catalyst A. The preparation starts by adding deionized water into a container and preheating it to 40-60° C. Then, a pre-heated organic additive is introduced into the water-containing container. Nickel salt is gradually added to the container. After a waiting period of about 10 minutes following the nickel addition, phosphoric acid is introduced into the container. Then another organic additive is added. The solution is then heated, targeting a temperature of 65-80° C. Molybdenum trioxide is added. The solution temperature is increased to 85-100° C. and stirring maintained for 5 hours. Then metal solution is impregnated on the alumina support at incipient wetness. The impregnated catalyst is dried at 100-110° C. to remove moisture. Finally, the dried catalyst is oxidized at 115-140° C. and is ready for performance testing.

### Example 3

Catalyst B was prepared according to the similar protocol as Catalyst A. However, Group VIb, Group VIII, Group Va and Group IIIb element concentrations in Catalyst A are different than Catalyst B.

### Example 4

The catalysts A and B were tested for performance. An amount of each catalyst was placed in separate reactors. Subsequently, the catalysts underwent a pre-sulfidation process. After that the feed in Example 1 was flowed over the catalyst beds and the products were collected and analyzed for sulfur content after removing hydrogen sulfide. In Table 2 is shown VGO testing data.

TABLE 2

| Test condition | Metric | Catalyst A | Catalyst B |
|---|---|---|---|
| 1800 psig, H₂/feed | S ppm in the liquid | 190 to 200 | 275 to 285 |
| scf/bbl of 6500, | product | | |
| LHSV of 1.14 | | | |
| 1800 psig, H₂/feed | S ppm in the liquid | 25 to 35 | 75 to 85 |
| scf/bbl of 6500, | product | | |
| LHSV of 1.28 | | | |

Catalyst A is the catalyst in this invention. Catalyst B is the reference catalyst. The lower sulfur in the liquid product, the higher activity of the catalyst.

### Specific Embodiments

While the following is described in conjunction with specific embodiments, it will be understood that this description is intended to illustrate and not limit the scope of the preceding description and the appended claims.

A first embodiment of the invention is a supported hydroprocessing catalyst comprising a shaped support having a void fraction of about 0.36 to 0.46, and a surface area by nitrogen BET between about 230 m²/g and 260 m²/g, 90-200 Angstroms median pore diameter, and at least 0.95 cc/g pore volume but not more than 1.10 cc/g pore volume wherein the supported hydroprocessing catalyst comprises about 26 to 30 wt % aluminum. An embodiment of the invention is one, any or all of prior embodiments in this paragraph up through the first embodiment in this paragraph wherein the molar ratio of aluminum to Group VIb, Group VIII, Group Va and Group IIIb elements range from Al: Group VIb 4.8-5.6, Al: Group VIII 14.9-19.0, Al: Group Va 9.6-12.7, and Al: Group IIIb 112.5-228.2. An embodiment of the invention is one, any or all of prior embodiments in this paragraph up through the first embodiment in this paragraph having a volatiles content between about 18 to 22 wt %. An embodiment of the invention is one, any or all of prior embodiments in this paragraph up through the first embodiment in this paragraph having an N2 BET surface area between about 230 m2/g and 260 m2/g. An embodiment of the invention is one, any or all of prior embodiments in this paragraph up through the first embodiment in this paragraph wherein a Group IIIb metal is dispersed by mulling or mixing in a forming step and wherein Group VIb, Group VIII and Group Va elements are prepared simultaneously as an aqueous solution in a single vessel and added to the shaped support in a single step.

A second embodiment of the invention is a process of making a hydroprocessing catalyst comprising dispersing a Group 3 metal by mulling or mixing in a single forming step and adding Group VIb, Group VIII and Group Va elements to a gamma alumina support in a single step. An embodiment of the invention is one, any or all of prior embodiments in this paragraph up through the first embodiment in this paragraph wherein the gamma alumina support is from a single source. An embodiment of the invention is one, any or all of prior embodiments in this paragraph up through the first embodiment in this paragraph wherein the Group VIb, Group VIII and Group Va elements are in a single impregnating solution that is added to the gamma alumina support. An embodiment of the invention is one, any or all of prior embodiments in this paragraph up through the first embodiment in this paragraph, wherein phosphoric acid is to the impregnating solution. An embodiment of the invention is one, any or all of prior embodiments in this paragraph up through the first embodiment in this paragraph, wherein the alumina support catalyst is comprising up to 5% wt peptizing agent based on dry weight of alumina. An embodiment of the invention is one, any or all of prior embodiments in this paragraph up through the first embodiment in this paragraph, wherein the alumina support catalyst comprising up to 10% wt organic additive of the alumina carrier. An embodiment of the invention is one, any or all of prior embodiments in this paragraph up through the first embodiment in this paragraph, wherein up to 5.0 wt % of nickel and/or cobalt as oxide based on the weight of oxide form of catalyst. An embodiment of the invention is one, any or all of prior embodiments in this paragraph up through the first embodiment in this paragraph, wherein up to 30 wt % of molybdenum as oxide based on the weight of oxide form of catalyst. An embodiment of the invention is one, any or all of prior embodiments in this paragraph up through the first embodiment in this paragraph wherein the impregnating solution comprises at least one tridentate carboxylic acid and at least one tetradentate aminocarboxylic acid. An embodiment of the invention is one, any or all of prior embodiments in this paragraph up through the first embodiment in this paragraph wherein the impregnating solution comprises a molar ratio of tridentate carboxylic acid to Group VIII metal of at least 1.55 to 1. An embodiment of the invention is one, any or all of prior embodiments in this paragraph up through the first embodiment in this paragraph wherein the impregnating solution comprises a molar ratio of tetradentate aminocarboxylic acid: Group VIII metal of at least 0.151. An embodiment of the invention is one, any or all of prior embodiments in this paragraph up through the first embodiment in this paragraph wherein after impregnation with the impregnating solution, the impregnated catalyst is subjected to an oxidizing atmosphere. An embodiment of the invention is one, any or all of prior embodiments in this paragraph up through the first embodiment in this paragraph wherein the supported hydroprocessing catalyst is sulfided.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims. In the foregoing, all temperatures are set forth in degrees Celsius and, all parts and percentages are by weight, unless otherwise indicated.

1. A supported hydroprocessing catalyst comprising a shaped support having a void fraction of about 0.36 to 0.46, and a surface area by nitrogen BET between about 230 m²/g and 260 m²/g, 90-200 Angstroms median pore diameter, and at least 0.95 cc/g but not more than 1.10 cc/g pore volume wherein the supported hydroprocessing catalyst comprises about 26 to 30 wt % aluminum.

2. The supported hydroprocessing catalyst of claim 1 wherein the molar ratio of aluminum to Group VIb, Group VIII, Group Va and Group IIIb elements range from Al: Group VIb 4.8-5.6, Al: Group VIII 14.9-19.0, Al: Group Va 9.6-12.7, and Al: Group IIIb 112.5-228.2.

3. The supported hydroprocessing catalyst of claim 1 having a volatiles content between about 18 to 22 wt %.

4. The supported hydroprocessing catalyst of claim 1 having an N₂ BET surface area between about 230 m²/g and 260 m²/g.

5. The supported hydroprocessing catalyst of claim 1 wherein a Group IIIb metal is dispersed by mulling or mixing in a forming step and wherein Group VIb, Group VIII and Group Va elements are prepared simultaneously as an aqueous solution in a single vessel and added to the shaped support in a single step.

6. A process of making a hydroprocessing catalyst comprising dispersing a Group 3 metal by mulling or mixing in a single forming step and adding Group VIb, Group VIII and Group Va elements to a gamma alumina support in a single step.

7. The process of claim 6 wherein said gamma alumina support is from a single source.

8. The process of claim 6 wherein said Group VIb, Group VIII and Group Va elements are in a single impregnating solution that is added to said gamma alumina support.

9. The process of claim 6, wherein phosphoric acid is to the impregnating solution.

10. The process of claim 6, wherein the alumina support catalyst is comprising up to 5% wt peptizing agent based on dry weight of alumina.

11. The process of claim 6, wherein the alumina support catalyst comprising up to 10% wt organic additive of the alumina carrier.

12. The process of claim 6, wherein up to 5.0 wt % of nickel and/or cobalt as oxide based on the weight of oxide form of catalyst.

13. The process of claim 6, wherein up to 30 wt % of molybdenum as oxide based on the weight of oxide form of catalyst.

14. The process of claim 7 wherein said impregnating solution comprises at least one tridentate carboxylic acid and at least one tetradentate aminocarboxylic acid.

15. The process of claim 8 wherein said impregnating solution comprises a molar ratio of tridentate carboxylic acid to Group VIII metal of at least 1.55 to 1.

16. The process of claim 8 wherein said impregnating solution comprises a molar ratio of tetradentate aminocarboxylic acid: Group VIII metal of at least 0.15:1.

17. The process of claim 8 wherein after impregnation with the impregnating solution, the impregnated catalyst is subjected to an oxidizing atmosphere.

18. The process of claim 8 wherein the supported hydroprocessing catalyst is sulfided.
